(19) United States
(12) Patent Application Publication
(10) Pub. No.: US 2009/0200256 A1
(43) Pub. Date: Aug. 13, 2009

(54) SAFETY DEVICE FOR CABLE-LIFTING APPARATUS

(75) Inventors: Felice VINATI, Castegnato (IT); Samuele VINATI, Brescia (IT); Matteo VINATI, Castegnato (IT)

Correspondence Address: BROWDY AND NEIMARK, P.L.L.C.;624 NINTH STREET, NW, SUITE 300, WASHINGTON, DC, 20001-5303, US

(73) Assignee: VINATI FELICE, Castegnato (IT)

(21) Appl. No.: 12/367,692

(22) Filed: Feb. 9, 2009

(30) Foreign Application Priority Data
Feb. 13, 2008 (IT) MI2008A000227

(51) Int. Cl. B66C 15/06

(52) U.S. Cl. 212/276

(57) ABSTRACT

A safety device for application to cable lifting apparatus, where the apparatus comprises a mobile tackle to which, via a system of cables, a grappling element for a load is connected, the safety device being characterised in that it is provided with means for detecting a displacement from a vertical of at least a cable of the cables supporting the grappling element for the load, alarm means of acoustic and/or visual and/or lifting operation shutdown type, which are associated to the means for detecting the displacement from the vertical, being destined to enter into function if the displacement from the vertical of the at least a cable exceeds at least a first predetermined threshold.

The invention relates to a safety device for cable-lifting apparatus, such as bridge cranes, construction-sector cranes and like apparatus destined to raise and move heavy loads.

As is known, bridge cranes are machines destined to raise and move materials and goods, either in the open or in closed environments, and are generally constituted by a horizontally-mobile bridge moving along a pair of rails and provided with a crossbar on which tackle is mounted which can move horizontally along the crossbar of the bridge and to which tackle a hoist is connected provided with a hook for grappling and raising the objects.

One or more cables are applied to the tackle, which cables, with a system of hoists, pulleys and hooks, enable weights to be raised and moved.

Though the bridge crane is a lifting apparatus subject to legal standard specifications, both with regard to construction and in terms of periodical verifications, a technical problem remains unsolved, which is substantially connected to the safety of the operators working the apparatus.

During the use of the tackle it might shift considerably from the vertical, giving rise to the possibility of pendular oscillations of the hook and the heavy object being transported, with the grave risk that it might go out of control and strike one or more operators, with the serious possibility of occasioning a grave accident.

The above-described problems can also obtain during use of other cabled apparatus for raising loads, such as for example cranes in the construction industry; these are also resolvable with the present invention.

An aim of the present invention is to obviate the above-cited drawbacks, by means of a safety device for cable lifting apparatus which signals a situation of danger to the operators.

A further aim of the invention is to realise a safety device which offers the possibility of graduating the danger signal, according to the situations which arise.

A further aim of the invention is to realise a safety device which offers the faculty of automatically stopping lifting and moving operations of the load.

A further aim of the invention is to provide a relevant improvement in safety in the use of cable lifting plants which is rational, reliable and relatively inexpensive.

These aims are attained thanks to a safety device which can be applied to a cable-lifting device, where the apparatus comprises a mobile tackle to which a grapping element for a load is connected, via a cable system, the safety device being provided with means for detecting a displacement from the vertical of at least one of the cable, which means are acoustic and/or visual and/or involve a shutdown means of the lifting or moving operations, and which means are set off or intervene if the detected displacement from the vertical of the cable exceeds at least a first predetermined threshold.

In particular, in the device of the invention the means for detecting the displacement from the vertical of the cable holding up the grappling element for the load comprise a joystick lever connected, by means of a rigid connection element, to the cable where the displacement is to be controlled.

Further, the means for detecting the displacement from the vertical of the cable are connected to an electronic control panel provided with a software program that associates a first alarm signal to the exceeding of a first displacement threshold from the vertical, which first alarm signal can be acoustic and/or visual and/or can be constituted by shut-down means of the raising or displacing operations of the load.

The program can also associate to the exceeding of a second threshold of the displacement from the vertical, where the second threshold defines a displacement from the vertical which is greater than the first threshold, a second acoustic and/or visual alarm signal having a greater intensity than the first.

Further characteristics of the invention can be deduced from the dependent claims.

Further characteristics and advantages of the invention will emerge from a reading of the following description provided by way of non-limiting example, with the aid of the figures illustrated in the accompanying figures of the drawings, in which:

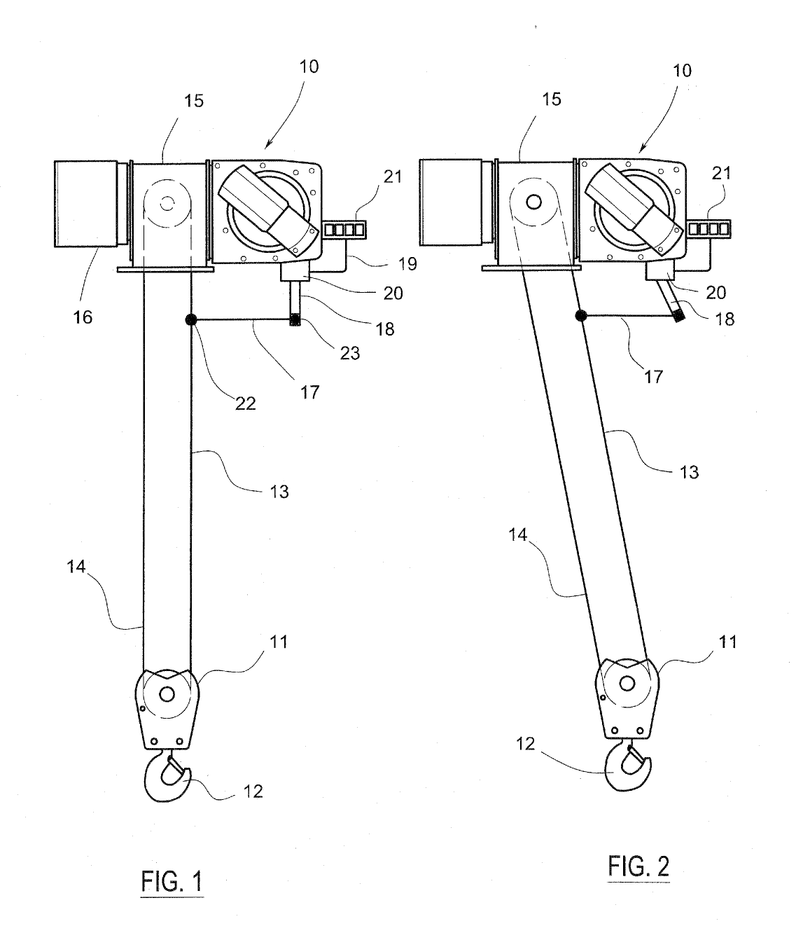

FIG. 1 is a schematic view of the safety device of the invention, in a vertical load position; and

FIG. 2 is a schematic view of the safety device of the invention, in a non-vertical load position and in a situation of potential danger.

FIG. 1 and 2 illustrate the safety device for a cable-lifting device of the invention, denoted in its entirety by reference number 10.

FIG. 1 schematically illustrates a hoist 11, provided with a hook 12, which is destined to raise or lower a load by means of a cable system 13, 14, activated via a tackle 15 mounted on the crossbar 16, in a situation in which the load (not illustrated for reasons of simplicity) is vertical and thus there are no risks of oscillation of the load. In this figure the cables are shown in the vertical position.

A first end 22 of a rigid connection element 17 is connected to the fixed cable 13, which rigid connection element 17 is fixedly connected by an end 23 thereof to a lever 18 of a joystick 20.

Further, the joystick 20 is connected, for example by means of connecting cables 19, to an electronic control device 21. Other connecting means between the joystick 20 and the control device 21 are possible, such as for example a wireless connection.

The functioning of the safety device of the invention will now be described with particular reference to FIG. 2, which illustrates the tackle 11, the hook 12 and the cables 13 and 14 in a non-vertical loading position.

The joystick 20 and the electronic control connected thereto can be mounted on the crossbar 16 of the bridge crane.

The described safety device can also be applied to other cable lifting apparatus destined to raise and move heavy loads.

Each displacement of the cable from the vertical, such as the one represented in FIG. 2, and which can occur, for example, during man-handling of the hook 12 and possibly also the load hooked on to the hook, is transmitted by effect of the presence of the rigid connecting element 17 to the lever 18 of the joystick 20, which joystick 20 is thus subject to displacements which are synchronised and proportional to the displacements of the cable 13.

When these displacements exceed a first predetermined threshold of swing from the rest position of the joystick lever, which in the illustrated example is the vertical, the electronic control emits a first acoustic and/or visual alarm signal.

If a second threshold of displacement from the rest position of the joystick lever is exceeded, where the second threshold of displacement relates to a greater displacement with respect to the first threshold, the electronic control emits a second acoustic and/or visual alarm signal having a greater intensity with respect to the first alarm signal.

In this way the operators can use the lifting apparatus safely, as the first displacement threshold of the cable from the vertical generates however a first notice of risk, but at the same time allows limited movements of the hook and the load possibly hooked thereon, which are in any case necessary for the use of the bridge crane.

The second threshold is, however, a true and proper alarm signal for the operators.

Obviously it would be possible to have safety devices having more than two calibrated thresholds, should circumstances demand this.

In the invention it is not necessary to have the cable 13 and the lever 18 of the joystick 20 always parallel to one another. It is sufficient that during calibration of the plant the first and second alarm thresholds are defined at predetermined positions of displacement of the joystick lever from the rest position thereof.

In addition or alternatively to the above-described signalling means, it is possible to associate the determination of the danger threshold with means for interrupting the lifting or displacing means of the load, such that for example the lifting apparatus blocks on exceeding the risk condition.

Obviously modifications or improvements can be brought to the invention as described herein, dictated by contingent motives or details, without its forsaking the ambit of the invention as claimed herein below.

In particular, as an alternative to the joystick other electronic means could be used for measuring a displacement from the vertical of the cable, for example contemporaneously measuring a linear displacement of the cable with respect to two non-coinciding different vertical axes by means of the use of length measuring devices.

Also it would be possible, for the above-described use, to use a pair of accelerometers to measure displacements of the cable from the vertical.

The general principle is thus to detect the displacement from the vertical of at least one of the cables which support the grapping element for the load, and to associate at least a first alarm signal to that displacement should it exceed a predetermined threshold.

1). A safety device for application to a cable-lifting apparatus, where the apparatus comprises a mobile tackle to which, via a system of cables, a grappling element for a load is connected, the safety device being characterised in that it is provided with means for detecting a displacement from a vertical of at least a cable of the cables supporting the grappling element for the load; alarm means of an acoustic and/or a visual and/or a lifting-operation shutdown type, which are associated to the means for detecting the displacement from the vertical, being destined to enter into function if the displacement from the vertical of the at least a cable under displacement-detecting control exceeds at least a first predetermined threshold.

2) The safety device of claim 1, characterised in that the means for detecting the displacement from the vertical of the at least a cable of the cables supporting the grappling element for the load comprise a joystick lever connected, via a rigid connecting element, to the cable under displacement-detecting control.

3). The safety device of claim 2, characterised in that the rigid connecting element is connected to a first end of the cable fixed to the lifting apparatus.

4). The safety device of claim 1, characterised in that the means for detecting the displacement from the vertical comprise means for contemporaneously measuring a linear displacement of the cable with respect to two vertical axes which are different and not coincident.

5). The safety device of claim 1, characterised in that the means for detecting the displacement from the vertical comprise two accelerometers applicable to the cable.

6). The safety device of claim 1, characterised in that the means for detecting the displacement from the vertical are connected to an electronic control device provided with a software program which program associates a first alarm signal of an acoustic and/or a visual and/or a lifting-shutdown type or a load-displacement halting type to an exceeding of a first threshold from the vertical.

7). The safety device of claim 6, characterised in that on an exceeding of a second threshold of displacement by the cable, the second threshold defining a greater displacement than the first displacement, the electronic control generates a second acoustic and/or a visual alarm signal having a greater intensity than the first alarm signal, or halts load-lifting or load-displacement operations.

8). The safety device of claim 6 or 7, characterised in that the first and second displacement thresholds are defined on a basis of corresponding displacements of the joystick lever from a rest position thereof.

9). The safety device of claim 8, characterised in that calibrations defining the first and second alarm thresholds are effected in positions in which the cable subjected to measurements of displacement from the vertical and the joystick lever are not parallel to one another.
